(19) United States
(12) Patent Application Publication
(10) Pub. No.: US 2024/0184862 A1
(43) Pub. Date: Jun. 6, 2024

(54) PERSONAL INFORMATION SYSTEM

(71) Applicant: DENSO CORPORATION, Kariya-city (JP)

(72) Inventors: Natsuko KURATA, Kariya-city (JP); Asuka SAKAI, Kariya-city (JP); Taro KOBAYASHI, Kariya-city (JP); Masafumi NOHARA, Kariya-city (JP); Kazuhiro MATSUI, Kariya-city (JP); Haozhou Li, Kariya-city (JP); Keiji OKAMOTO, Kariya-city (JP); Jinhae CHOI, Kariya-City (JP)

(21) Appl. No.: 18/440,728

(22) Filed: Feb. 13, 2024

Related U.S. Application Data
(63) Continuation of application No. PCT/JP2022/026826, filed on Jul. 6, 2022.

(30) Foreign Application Priority Data
Aug. 17, 2021 (JP) 2021-132926

(51) Int. Cl. G06F 21/31

(52) U.S. Cl. CPC G06F 21/31

(57) ABSTRACT

A personal information system includes an acquisition unit, a storage unit, a personal storage unit, and a control unit. The acquisition unit is configured to identify an occupant of a vehicle and acquire a status of the occupant. The storage unit stores usage history information of a vehicle device and state information of the occupant acquired by the acquisition unit. The personal storage unit is set for each occupant and is configured to retrieve, as personal information, the usage history information and the state information from the storage unit for each occupant and sequentially store the usage history information and the state information. The control unit is configured to perform control that utilizes the personal information stored in the personal storage unit to provide a service, in a manner matching characteristics of each occupant when operating the vehicle device.

### CROSS REFERENCE TO RELATED APPLICATION

The present application is a continuation application of International Patent Application No. PCT/JP2022/026826 filed on Jul. 6, 2022, which designated the U.S. and claims the benefit of priority from Japanese Patent Application No. 2021-132926 filed on Aug. 17, 2021. The entire disclosures of all of the above applications are incorporated herein by reference.

### TECHNICAL FIELD

The present disclosure relates to a personal information system.

### BACKGROUND

Conventionally, an information system has been used by an occupant of a vehicle.

### SUMMARY

According to an aspect of the present disclosure, a personal information system is configured to utilize personal information of an occupant of a vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing an overall configuration of a personal information system according to a first embodiment;

FIG. 2 is an explanatory diagram showing an overall configuration of the personal information system in a modification of the first embodiment; and

FIG. 3 is an explanatory diagram showing an overall configuration of a personal information system according to a second embodiment.

### DETAILED DESCRIPTION

Hereinafter, examples of the present disclosure will be described.

According to an example of the present disclosure, an in-vehicle device control system includes an in-vehicle device controlled (automatically adjusted) for vehicle occupants.

Specifically, an occupant transmits the fact that he or she has boarded the vehicle (who has boarded the vehicle) from a portable terminal to an occupant recognition system. In addition, a personal information list stores in advance each individual's preferences (for example, he/she likes the temperature of the air conditioner to be high) as personal information. Furthermore, an access policy list has preset priority rankings for occupants (ranking data indicating whose preferred information is to be applied with priority).

Based on the information on the personal information list and the access policy list, an automatic in-vehicle device adjustment system is designed to determine setting conditions for each of in-vehicle devices to match the preferences of the occupants with higher priority, while taking into account the priorities of the occupants, for the operation of the in-vehicle devices.

However, for example, when starting a new account and utilizing the occupant's personal information, the configuration described above requires time and effort to input the personal information, while the information input in such effort tends to be commonplace (name, height, weight, age, etc.), making it difficult to receive useful services related to a vehicle device based thereupon.

According to an example of the present disclosure, a personal information system is configured to utilize personal information. The personal information system comprises:
an acquisition unit configured to identify an occupant of a vehicle and acquire a state of the occupant;
a storage unit configured to store usage history information of a vehicle device and state information of the occupant acquired by the acquisition unit;
a personal storage unit configured to be set for each occupant, and configured to retrieve, as the personal information, the usage history information and the state information from the storage unit for each occupant and sequentially store the usage history information and the state information; and
a control unit configured to perform control that utilizes the personal information stored in the personal storage unit to provide a service in a manner matching characteristics of each occupant when the vehicle device is operated.

According to the present disclosure, since the personal information of an occupant is sequentially stored from the storage unit to the personal storage unit, it is possible to save efforts of the occupant himself/herself to input the personal information. In addition, the personal information is information that corresponds to characteristics of each occupant based on the usage history information of the vehicle device, thereby such information is set to include the characteristics and preferences of each occupant, for providing the service from the vehicle device, which are suitable for the occupant. The configuration may enable to facilitate acquisition of useful personal information and that allow occupants to enjoy services of vehicle devices that match their characteristics.

The following will describe embodiments for carrying out the present disclosure with reference to the drawings. In each of the embodiments, parts/configurations corresponding to elements described in the preceding embodiment(s) are denoted by the same reference numerals, and redundant explanation may be omitted. When only a part of a configuration is described in an embodiment, other preceding embodiment(s) may be applied to the other parts of such configuration. In each of the embodiments, not only parts which are specifically described as combinable but also other parts, which are not specifically described as combinable, are combinable at least partially as long as no adverse effect hinders such combination.

### First Embodiment

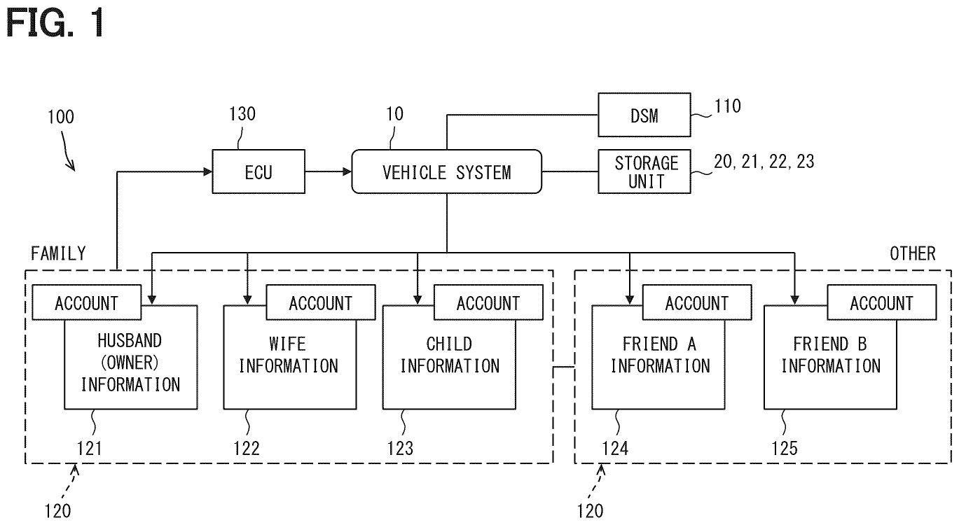

A personal information system 100 according to the first embodiment will be explained with reference to FIG. 1. The personal information system 100 utilizes personal information of an occupant of a vehicle to operate various vehicle devices 10 in a vehicle system installed in the vehicle in a manner that matches features and preferences (characteristics) of the vehicle occupant (i.e., to control the vehicle device 10 to provide a service).

The occupants of the vehicle include, for example, only a driver of the vehicle, or the driver and one or more other occupants. The occupants of the vehicle belong to a community formed by family members, friends, acquaintances with common interests, and the like. As for a format of the community, various settings can be made as described later.

The various vehicle devices 10 include, for example, an air conditioner, an audio device, an information device, an automatic driving device, and the like. The air conditioner controls temperature of the air inside the vehicle and an amount of air blown thereinto. The audio device plays videos and music. The information device presents various information (lifestyle information, knowledge information, etc.). The automatic driving device provides semi-automated or full-automated driving support to the driver regarding vehicle speed, inter-vehicle distance, driving lane setting, and the like.

The various vehicle devices 10 include a storage unit 20 that stores various data related to (a) control conditions such as operation input conditions and operation output conditions from the occupant, (b) occupant state information acquired by an acquisition unit 110 described later, and the like. As the storage unit 20, for example, a cloud storage unit 21 formed on the Internet, a terminal storage unit 22 of a potable terminal (terminal of the present disclosure) carried by the occupant, in addition to a vehicle storage unit 23 which is a hard disk provided in the vehicle device 10, or the like.

The various data related to the above-described control conditions correspond to an example of usage history information of the present disclosure, and more specifically, include a frequency of use of the vehicle device 10 by the occupant, setting conditions, and the like, indicative of high/low use frequency, setting condition is higher or lower than a standard condition, and the like.

Further, the occupant state information indicates identification of the occupant based on a pre-stored facial image of the occupant, and satisfaction level/dissatisfaction level and the like based on the occupant's facial expression, posture, and the like.

The personal information system 100 includes an acquisition unit 110, a personal storage unit 120, a control unit 130, and the like.

The acquisition unit 110 identifies an occupant in the vehicle and acquires (detects) the occupant's condition (facial expression, posture, and the like), by using a camera (a CMOS camera, a CCD camera, an infra-red camera or the like) or by using the camera and a biosensor (a body temperature sensor, a heart rate sensor, an electroencephalogram sensor, a myoelectric sensor, or the like), depending on a situation.

The camera is installed, for example, at a front of a ceiling inside the vehicle, captures a face and body of the occupant, and outputs the captured data to the storage unit 20. Note that, in a case where the vehicle is equipped with a driver status monitor (registered trademark, DSM) that provides driving support (alerts, automatic emergency braking, and the like) depending on the driver's condition (distracted attention, drowsiness, and the like), the camera used for driver status monitoring may be used for such purposes.

Further, the biosensor is attached to the body, a seat of the occupant or the like, for example, and detects biometric data of the occupant (body temperature, heart rate, brain waves, muscle condition, and the like), and stores the detected biometric data of the driver in the storage unit 20.

The personal storage unit 120 is set for each occupant, and includes, for example, a husband storage unit 121, a wife storage unit 122, a child storage unit 123, and the like, for a family community. Further, the personal storage unit 120 also includes a friend A storage unit 124, a friend B storage unit 125, and the like, for a community other than the family community, for example, a friends community.

In addition, for the family community, settings can be made in accordance with the family structure, to include a memory for grandparents and the like. Designation “Grandparents” is a relationship from a child's perspective. Furthermore, as a community other than the family, it is also possible to create a community of members who have common hobbies and common lessons, as well as a community of members who share the same vehicle.

The personal storage unit 120 (each of the storage units 121 to 125) is a unit that sequentially stores (accumulates) by retrieving, as personal information, all of the usage history information and the occupant state information, which are stored in the storage unit 20 of the vehicle device 10 for each occupant, based on identification information of the occupant acquired by the acquisition unit 110 from the storage unit 20. That is, in each of the storage units 121 to 125 of the personal storage unit 120, the personal information of each occupant is sorted by naming and is stored.

The personal storage unit 120 automatically stores the usage history information and the state information regarding each occupant, regardless of an intention of each occupant. Information related to each occupant's preferences is accumulated from the usage history information and the occupant state information (satisfied, dissatisfied), and the like, including contents not yet recognized by the occupant him/herself.

The control unit 130 is a unit that utilizes the personal information of each occupant in the personal storage unit 120 (each of the storage units 121 to 125) to control how services are provided to that match the characteristics (preferences) of each occupant when operating the vehicle device 10 (see details described later).

The personal information system 100 of the present embodiment has the above-described configuration, and the operation and effects thereof will be described below.

The acquisition unit 110 outputs the state information including the acquired identification information of the occupant to the storage unit 20 of the vehicle system. Then, the control unit 130 sequentially stores all of the personal information of each occupant in the personal storage unit 120 (each of the storage units 121 to 125) based on the identification information of each occupant in the storage unit 20.

Here, when the storage unit 20 is composed of a plurality of storage units as described above, that is, the cloud storage unit 21, the terminal storage unit 22, the vehicle storage unit 23, and the like, the personal information is formed by joining the information from each of the storage units 21, 22, and 23 by the control unit 130.

Then, when an account for operating the vehicle device 10 (occupant identification ID, password, and the like) is generated for each occupant, the control unit 130 associates each occupant's account and the personal information stored in the storage unit 120 (i.e., in each of the storage unit 121 to 125). Then, for providing a service (for controlling the operation of the vehicle device 10), the control unit 130 identifies a target person to whom the service is provided based on the account, and, based on the corresponding personal information, provides, for the target occupant, the service(s) that match the characteristics (preferences) thereof.

As described above, in the present embodiment, all of the occupant's personal information is sequentially stored from the storage unit 20 to the personal storage unit 120 (each of the storage units 121 to 125). Therefore, the configuration saves efforts for the occupant himself/herself to input the personal information. In addition, the personal information corresponds to information of the characteristics of each occupant based on the usage history information of the vehicle device 10. Therefore, the configuration suitably includes information regarding the characteristics and preferences of each occupant, thereby enabling the vehicle device 10 to provide services that match the occupant.

Further, when the storage unit 20 is composed of a plurality of storage units (each of the storage units 21 to 23), the personal information is formed by joining information from each of the storage units 21 to 23 by the control unit 130, thereby allowing the occupant to fully utilize the personal information of him/herself without omission.

Further, the control unit 130 associates the personal information with an account for operating the vehicle device 10 set for each occupant, and identifies a target person for providing the service based on the account. Therefore, the reliability of the service provided for the occupant is increasable.

### Modification of First Embodiment

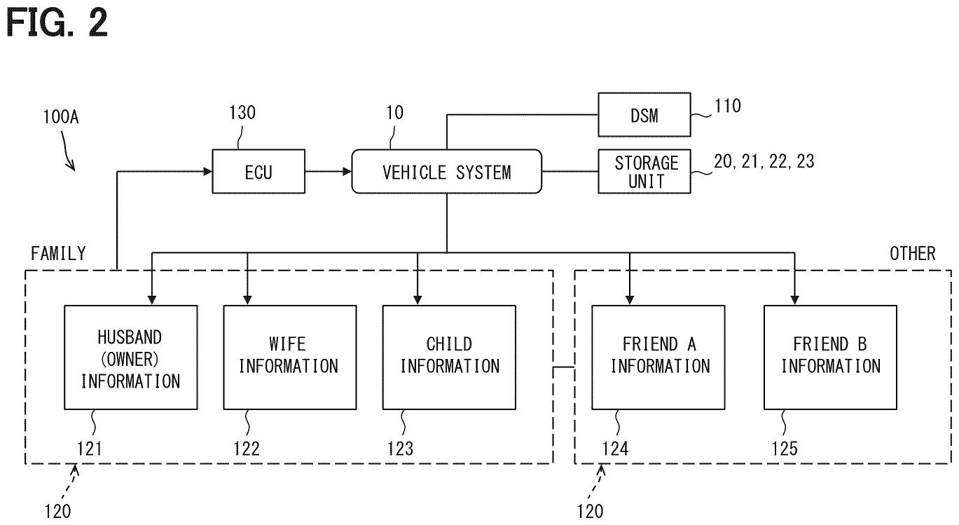

FIG. 2 shows a personal information system 100A in a modification of the first embodiment. In the personal information system 100A in this modification, the account settings described in the first embodiment are omitted. The control unit 130 identifies the target person for providing the service based on the state information acquired by the acquisition unit 110 (i.e., recognizes the target person from a facial image). In other words, even without setting up an account, the control unit 130 estimates the target person to whom the service will be provided based on the state information (facial image), and provides the service based on the occupant's personal information.

For example, a case will be explained in which a grandmother uses a vehicle to go to a hospital. The acquisition unit 110 recognizes from the facial image that the grandmother has gotten into the vehicle. In addition, the storage unit 20 and the personal storage unit 120 store the frequency of rides in the past, and also store a grandmother's health condition (she is estimated as healthy, ill or the like) from the grandmother's expression, posture, heartbeat, and the like acquired by the acquisition unit 110.

For example, the control unit 130 control the information device to provide information of health care and insurance regarding the grandmother as presentation information. In other words, the information device presents an optimal care content or insurance information (premium, guarantee amount), and the like based on the grandmother's health condition (the personal information).

In such manner, the acquisition unit 110 is enabled to identify the occupant without creating an account, making it possible to provide optimal services based on the occupant's state information.

### Second Embodiment

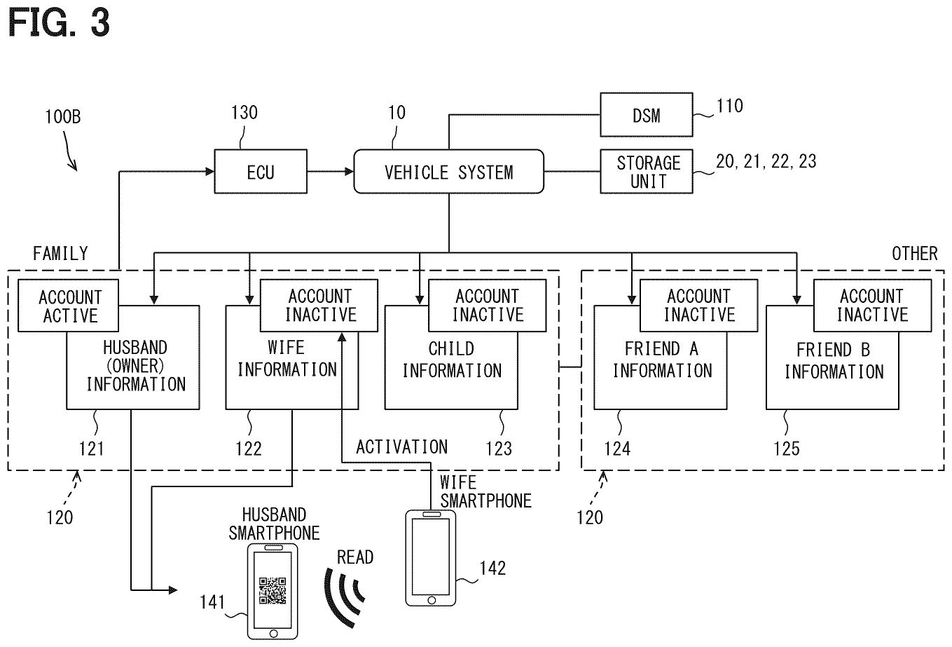

FIG. 3 shows a personal information system 100B in the second embodiment. In the personal information system 100B of the second embodiment, the personal information in the personal storage unit 120 (each of the storage unit 121 to 125) for each occupant is sharable by transmission and reception between portable terminals 141 and 142 carried by the occupant.

Specifically, the portable terminal 141 is, for example, for a husband, and the portable terminal 142 is, for example, for a wife. The husband transmits a QR code (registered trademark) from his portable terminal 141 to his wife's portable terminal 142 for activating his wife's personal information in the husband's account.

When the wife reads the QR code using the portable terminal 142, the wife's personal information is separated from the personal information of each occupants in the family community. By setting up her own account for such separated personal information, the wife's account and the wife's personal information are associated and activated. In other words, the wife becomes capable of receiving the service of the vehicle device 10 using her own account that she has set up.

In such manner, by transmitting and receiving information between the portable terminals 141 and 142, it becomes possible to easily set the personal information of a predetermined occupant for providing a service.

Note that, in one configuration, an occupant belonging to a community may switch to a different community at his or her own will. In such manner, it is possible to accumulate the personal information according to the community, making it possible to receive services that match the occupant's intentions.

### Other Embodiments

The disclosure in the present specification and drawings and the like is not limited to the exemplified embodiments. The present disclosure includes embodiments described above and modifications of the above-described embodiments made by a person skilled in the art. For example, the disclosure is not limited to components and/or combinations of elements presented in the embodiments shown herein. The present disclosure may be implemented in various combinations thereof. The disclosure may have additional components that can be added to the embodiments.

The present disclosure also includes modifications which have partial components/elements of the above-described embodiments omitted therefrom. The present disclosure also includes replacement or combination of components and/or elements between one embodiment and another. The disclosed technical scope is not limited to the description of the embodiment. It should be understood that some of the disclosed technical ranges are indicated by description of claims, and includes every modification within the equivalent meaning and the scope of description of claims.

The control unit and the method described in the present disclosure may be realized by a dedicated computer provided by configuring a processor and a memory programmed to perform one or more functions embodied by a computer program.

Alternatively, the control unit and the method described in the present disclosure may be realized by a dedicated computer provided by configuring a processor with one or more dedicated hardware logic circuits.

Alternatively, the control unit and the method described in the present disclosure may be realized by one or more dedicated computers configured as a combination of (a) a processor and a memory programmed to perform one or more functions, and (b) a processor configured by one or more hardware logic circuits.

Furthermore, the computer program may be stored in a computer-readable, non-transitory, tangible recording medium as an instruction executed by a computer.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A personal information system configured to utilize personal information, the personal information system comprising:
an acquisition unit configured to identify an occupant of a vehicle and acquire a state of the occupant;
a storage unit configured to store usage history information of a vehicle device and state information of the occupant acquired by the acquisition unit;
a personal storage unit
configured to be set for each occupant, and
configured to retrieve, as the personal information, the usage history information and the state information from the storage unit for each occupant and sequentially store the usage history information and the state information; and
a control unit configured to perform control that utilizes the personal information stored in the personal storage unit to provide a service in a manner matching characteristics of each occupant when the vehicle device is operated, wherein
the control unit is configured to
associate an account, which is set for each occupant when the vehicle device is operated, with the personal information and
identify a target person for providing the service based on the account.

2. The personal information system of claim 1, wherein
the storage unit includes a cloud storage unit on an Internet, a terminal storage unit of a terminal of the occupant, and a vehicle storage unit of the vehicle device, and
the personal information is formed by joining information in the cloud storage unit, information in the terminal storage unit, and information in the vehicle storage unit.

3. The personal information system of claim 1, wherein
the personal information in the personal storage unit for each occupant is configured to be sharable by transmission and reception among portable terminals carried by occupants.

4. A personal information system comprising:
a personal storage device configured to be set for each occupant;
a storage device;
at least one processor; and
at least one memory storing instructions configured to, when executed by the at least one processor, cause the at least one processor to:
identify an occupant of a vehicle and acquire a state of the occupant;
cause the storage device to store usage history information of a vehicle device and state information;
cause the personal storage device to retrieve, as personal information, the usage history information and the state information from the storage device for each occupant and sequentially store the usage history information and the state information;
perform control that utilizes the personal information stored in the personal storage device to provide a service in a manner matching characteristics of each occupant when the vehicle device is operated;
associate an account, which is set for each occupant when the vehicle device is operated, with the personal information; and
identify a target person for providing the service based on the account.
